(19) United States
(12) Patent Application Publication
(10) Pub. No.: US 2015/0186259 A1
(43) Pub. Date: Jul. 2, 2015

(54) METHOD AND APPARATUS FOR STORING DATA IN NON-VOLATILE MEMORY

(71) Applicant: SanDisk Technologies Inc., Plano, TX (US)

(72) Inventors: Nicholas James Thomas, Dundee (GB); Jonathan Hsu, Newark, CA (US); Igor Genshaft, Bat Yam (IL)

(73) Assignee: SanDisk Technologies Inc., Plano, TX (US)

(21) Appl. No.: 14/144,061

(22) Filed: Dec. 30, 2013

(51) Int. Cl. G06F 12/02

(52) U.S. Cl. CPC G06F 12/0246; G06F 2212/7201

(57) ABSTRACT

Apparatus and methods implemented therein are disclosed for storing data in flash memories. The apparatus comprises a flash memory having several physical blocks, a logical to virtual mapping table, a virtual to physical mapping table and a memory controller. The memory controller retrieves a virtual block address from the logical to virtual mapping table. The virtual block address corresponds to an entry in the virtual to physical mapping table. The entry in the virtual to physical mapping table contains a reference to a physical block. The memory controller uses the virtual block address to retrieve the reference to the physical block and stores data in the physical block. The memory controller copies the stored data from the physical block to a second physical block. The memory controller then replaces the reference to the physical block contained in the entry of the virtual to physical mapping table with a reference to the second physical block.

### TECHNICAL FIELD

This application relates generally to managing data in a memory system. More specifically, this application relates to copying data between physical storage blocks in a solid state storage device and remapping references to the physical storage blocks.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Non-volatile memory systems, such as flash memory, are used in digital computing systems as a means to store data and have been widely adopted for use in consumer products. Flash memory may be found in different forms, for example in the form of a portable memory card that can be carried between host devices or as a solid state disk (SSD) embedded in a host device. These memory systems typically work with data units called “pages” that can be written, and groups of pages called “blocks” that can be read and erased, by a storage manager often residing in the memory system. Each of the blocks may be associated with a physical address.

In a SSD there is a logical to physical mapping table or other data structure that typically stores a map of all logical addresses to physical addresses in the SSD. When data is written to a flash memory, the mapping table or other data structure that tracks the location of data in the flash memory must be updated. The time involved in updating data structures for file systems to reflect changes to files and directories, and accessing these data structures, may affect the performance of the storage device.

### SUMMARY

According to one aspect, a method for storing data in non-volatile memory by a memory controller is disclosed. In one embodiment, the memory controller receives information from a host. The information includes data that is to be stored and a logical block address. Based on the logical block address, a virtual block address corresponding to the logical block address is retrieved from a logical to virtual mapping table. The retrieved virtual block address corresponds to an entry in a virtual to physical mapping table. The entry includes a reference to a first physical block. The data in the first physical block based on the reference. The stored data is copied from the first physical block to a second physical block. The reference to the first physical block in the entry is replaced with a reference to the second physical block without changing the virtual block address associated with the logical block address.

According to another aspect, a method for copying data stored in a first physical block of a flash device to a second physical block of the flash device is disclosed. In an embodiment, the first physical block has a cell density different from a cell density of the second physical block. After data is copied, a reference to the first storage block contained in an entry of a virtual to physical block address is replaced with a reference to the second storage block. The entry corresponds to a respective logical block address stored in a logical to virtual mapping table.

### BRIEF DESCRIPTION OF THE DRAWINGS

FIG. 1 illustrates a block diagram of host and storage device according to one embodiment.

FIG. 2A illustrates an example physical memory organization of the memory in the storage device of FIG. 1.

FIG. 2B shows an expanded view of a portion of the physical memory of FIG. 2.

FIG. 3 is a block diagram of an exemplary memory mapping table that may be utilized to perform remapping of physical block according to an embodiment.

FIG. 4 is a block diagram of an example memory controller that may perform remapping of physical blocks of memory.

FIG. 5 is a flow diagram of an example method that may be implemented by the memory controller of FIG. 4.

FIG. 6 is a flow diagram of another example method that may be implemented by the memory controller of FIG. 4, in accordance with an embodiment.

FIG. 7 is a flow diagram of another example method that may be implemented by the memory controller of FIG. 4, in accordance with an embodiment.

### DETAILED DESCRIPTION

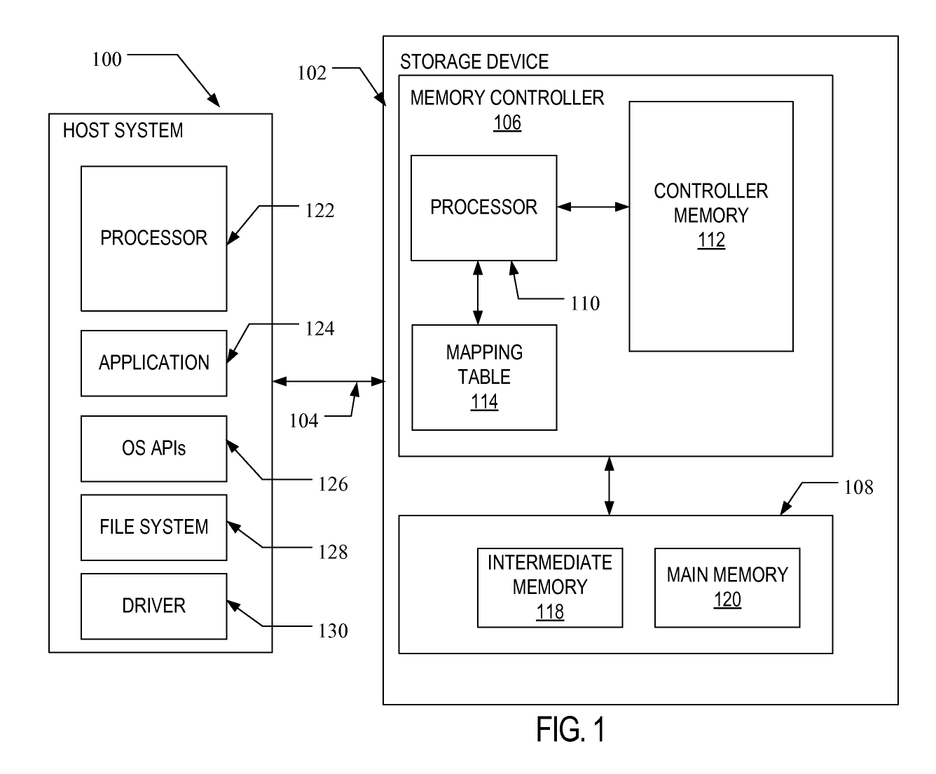

A flash memory system suitable for use in implementing aspects of the invention is shown in FIG. 1. A host system 100 stores data into, and retrieves data from, a storage device 102. The storage device 102 may be embedded in the host system 100 or may exist in the form of a card or other removable drive, such as a solid state disk (SSD) that is removably connected to the host system 100 through a mechanical and electrical connector. The host system 100 may be any of a number of fixed or portable data generating devices, such as a personal computer, a mobile telephone, a personal digital assistant (PDA), or the like. The host system 100 communicates with the storage device over an input/output interface 104.

The storage device 102 contains a memory controller 106 and a memory 108. As shown in FIG. 1, memory controller 106 includes a processor 110 and a controller memory 112. The processor 110 may comprise a microprocessor, a microcontroller, an application specific integrated circuit (ASIC), a field programmable gate array, a logical digital circuit, or other now known or later developed logical processing capability. The controller memory 112 may include volatile memory such as random access memory (RAM) and/or non-volatile memory such as read only memory (ROM).

As discussed in more detail below, the storage device 102 may include functions for memory management. In operation, the processor 110 may execute memory management instructions (which may be resident in controller memory 112) for operation of memory management functions. The memory management functions may control the assignment of the one or more portions of the memory 108 within storage device 102.

The memory 108 may include non-volatile memory (such as flash memory). One or more memory types may be included in memory 108. For example, the intermediate memory 118 may be configured in a single level cell (SLC) type of flash configuration having a one bit per cell capacity while the main memory 120 may consist of a multi-level cell (MLC) type flash memory configuration having two or more bit per cell capacity to take advantage of the higher write speed of SLC flash and the higher density of MLC flash. As an example, if a physical block in the intermediate memory is capable of storing 1024 bits and if a physical block in the main memory consists of cells having a 4 bit per cell capacity, a block of data having a size of 1024 bits may be stored in the main memory in a physical block with 256 cells (1024/4).

Generally, writing data to a SLC type flash memory takes less time than writing the same data to an MLC type flash memory. Therefore, it may be desirable to first store data into an SLC type flash memory and then subsequently move the data to a MLC type flash memory. Different combinations of flash memory types are also contemplated for the intermediate storage 118 and main memory 120.

The intermediate memory 118 and the main memory 120 include physical blocks of flash memory that each consists of a group of pages, where a block is a group of pages and a page is a smallest unit of writing in the memory. The physical blocks in the memory include operative blocks that are represented as logical blocks to the file system 128. The storage device 102 may be in the form of a portable flash drive, an integrated solid state drive or any of a number of known flash drive formats. In yet other embodiments, the storage device 102 may include only a single type of flash memory having one or more partitions.

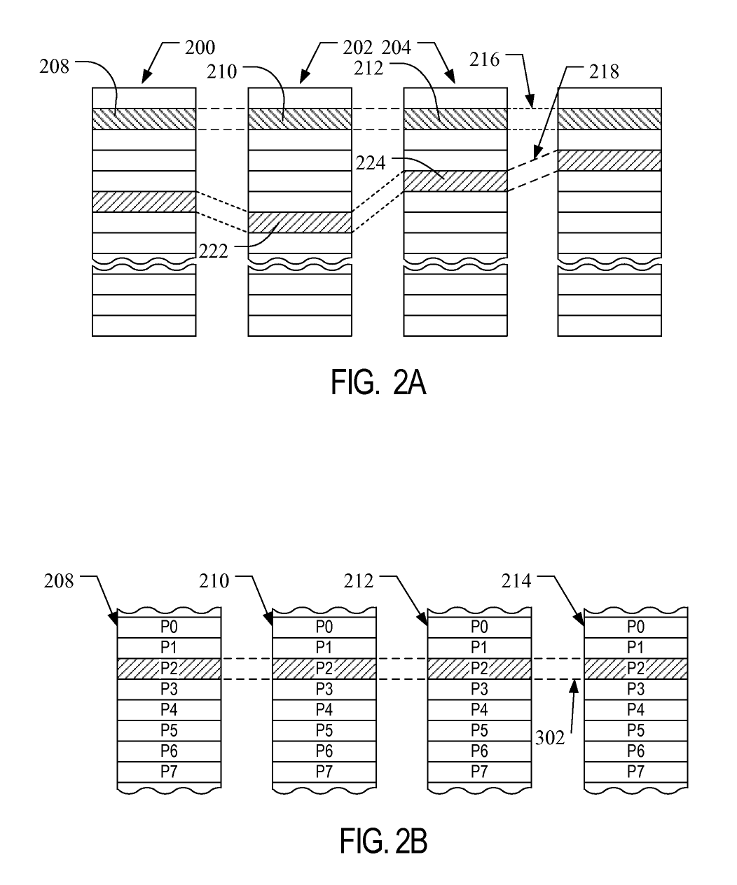

Referring to FIG. 2A, the intermediate and main memories 118, 120 (e.g. SLC and MLC flash respectively) may be arranged in blocks of memory cells. In the example of FIG. 2, four planes or sub-arrays 200, 202, 204 and 206 memory cells are shown that may be on a single integrated memory cell chip, on two chips (two of the planes on each chip) or on four separate chips. The specific arrangement is not important to the discussion below and other numbers of planes may exist in a system. The planes are individually divided into blocks of memory cells shown in FIG. 2A by rectangles, such as blocks 208, 210, 212 and 214, located in respective planes 200, 202, 204 and 206. There may be dozens or hundreds of blocks in each plane. Blocks may be logically linked together to form a metablock that may be erased as a single unit. For example, blocks 208, 210, 212 and 214 may form a first metablock 216. The blocks used to form a metablock need not be restricted to the same relative locations within their respective planes, as is shown in the second metablock 218 made up of blocks 220, 222, 224 and 226.

The individual blocks are in turn divided for operational purposes into pages of memory cells, as illustrated in FIG. 2B. The memory cells of each of blocks 208, 210, 212 and 214, for example, are each divided into eight pages P0-P7. Alternately, there may be 16, 32 or more pages of memory cells within each block. A page is the unit of data programming and reading within a block, containing the minimum amount of data that are programmed or read at one time. A metapage 302 is illustrated in FIG. 2B is formed of one physical page for each of the four blocks 208, 210, 212 and 214. The metapage 302 includes the page P2 in each of the four blocks but the pages of a metapage need not necessarily have the same relative position within each of the blocks. A metapage is the maximum unit of programming. The blocks disclosed in FIGS. 2A-2B are referred to herein as physical blocks because they relate to groups of physical memory cells as discussed above. As used herein, a logical block is a virtual unit of address space defined to have the same size as a physical block. Each logical block includes a range of logical block addresses (LBAs) that are associated with data received from a host 100. The LBAs are then mapped to one or more physical blocks in the storage device 102 where the data is physically stored.

In an exemplary embodiment discussed herein, an LBA may be mapped to an intermediary virtual block address and the virtual block address in turn may be mapped to a physical block. In this embodiment, data stored in one physical block, an SLC type physical block for example, may be copied to an MLC type physical block. After copying the data, virtual block address may be remapped to point to the MLC type physical block. One advantage of performing the remapping using the intermediate virtual block address is that the logical block address associated with the data is not changed. Because the logical block address associated with the data is not changed, the host system may be agnostic to the remapping of the logical block address and the copying of the data from one physical block to a second physical block.

Referring again to FIG. 1, the host 100 may include a processor 122 that runs one or more application programs 124. The application programs 124, when data is to be stored on or retrieved from the storage device 102, communicate through one or more operating system application programming interfaces (APIs) 126 with the file system 128. The file system 128 may be a software module executed on the processor 122 and manages the files in the storage device 102. The file system 128 manages clusters of data in logical address space. Common operations executed by a file system 128 include operations to create, open, write (store) data, read (retrieve) data, seek a specific location in a file, move, copy, and delete files. The file system 128 may be circuitry, software, or a combination of circuitry and software.

Accordingly, the file system 128 may be a stand-alone chip or software executable by the processor of the host 100. A storage device driver 130 on the host 100 translates instructions from the file system 128 for transmission over a communication channel 104 between the host 100 and storage device 102. The interface for communicating over the communication channel may be any of a number of known interfaces, such as SD, MMC, USB storage device, SATA and SCSI interfaces. A file system data structure 132, such as a file allocation table (FAT), may be stored in the memory 108 of the storage device 102. Although shown as residing in the binary intermediate portion 118 of the memory 108, the file system data structure 132 may be located in the main memory 120 or in another memory location on the storage device 102.

In addition to the user data and host-generated file system tables that may be stored in flash memory on the storage device, the storage device itself stores and maintains a mapping table 114 or other data structure that tracks the logical addresses supplied by the host file system and the physical addresses where the storage device is keeping the data. One way to maintain a primary mapping table of all logical to physical address relationships (a logical to physical mapping table) in the storage device is to maintain the entire table in flash memory (such as NAND flash) and to then copy the entire table into mapping table 114 in the controller 106 of the storage device 102.

In a preferred embodiment described herein the primary mapping table is replaced with a logical to virtual mapping table and a virtual to physical mapping table. In this embodiment, one or more entries in the logical to virtual mapping table may include a reference to an entry in the virtual to physical to mapping table. The entry in virtual to physical mapping table may include a reference to a physical block where the memory controller may store data received from the host system 100.

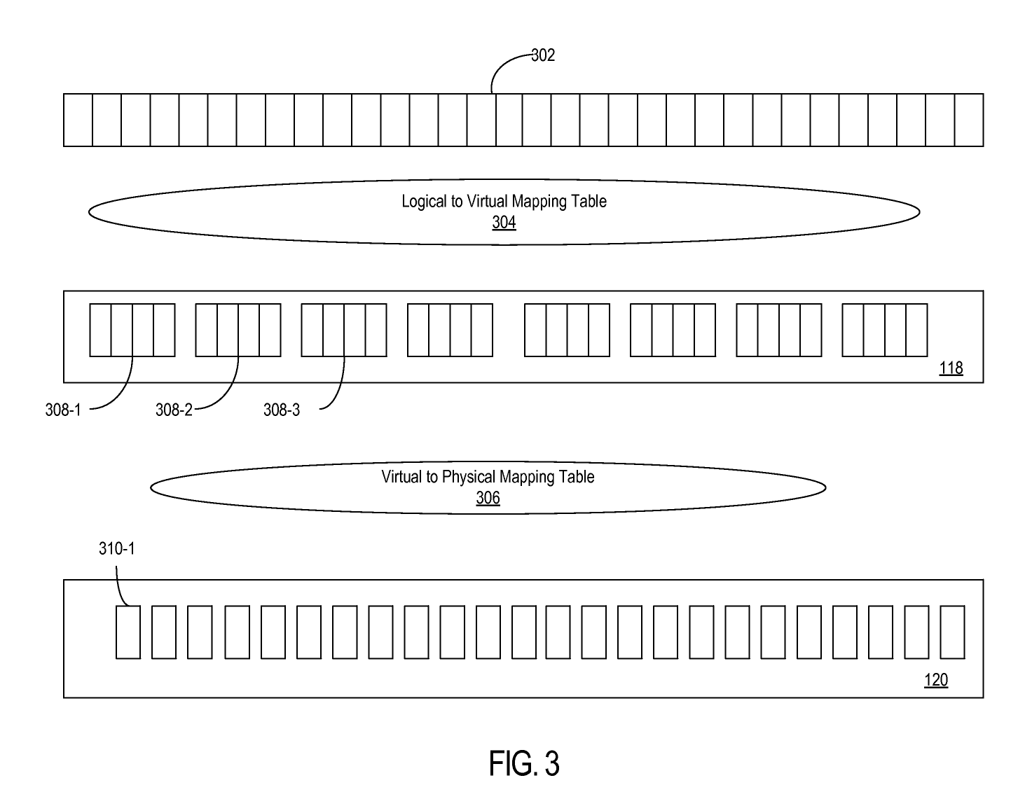

FIG. 3 is a block diagram of a preferred embodiment of the mapping table 114 and memory 108 of FIG. 1. The mapping table 114 comprises a logical to virtual mapping table 304 and a virtual to physical mapping table 306. The number of entries in the logical to virtual mapping table 304 is an integer multiple of the number of entries in the virtual to physical mapping table 306. In this embodiment, an entry in the logical to virtual mapping table 304 corresponds to a logical block address. Separately, the integer number of entries in the logical to virtual mapping table 304 may include a reference to a single entry in the virtual to physical mapping table 306. An entry in the virtual to physical mapping table 306 may include a reference to a single physical block or a reference to the start of a group of contiguous physical blocks.

In this embodiment, the memory 108 comprises intermediate memory 118 and main memory 120. By way of example and without limitation, intermediate memory 118 comprises physical blocks consisting of SLC. Main memory 120 comprises physical blocks consisting of MLC. By way of example and without limitation, an MLC in a physical block in main memory 120 is capable of storing 4 bits of information, in contrast to an SLC in a physical block in intermediate memory 118 is capable of storing 1 bit of information. Thus, data stored in four physical blocks, 308-1 for example, in intermediate memory 118 may be copied and stored in one physical block, 310-1, of main memory 120. Correspondingly, in this example, four entries in the logical to virtual mapping table 304 may include a reference to a single entry in the virtual to physical mapping table 306.

A memory controller such as memory controller 106 of FIG. 1 may operate to copy data stored in four contiguous physical blocks 308-1 of intermediate memory 118 to a single physical block 310-1 in main memory 120. Before the copying of data, an entry in the virtual to physical mapping table 306 may reference the first of four contiguous physical blocks 308-1 in intermediate memory 118. In this embodiment, in response to copying data to a single physical block 310-1 in main memory 120, memory controller 106 may remap the entry in the virtual to physical mapping table 306 to reference the single physical block in main memory 120. The entries in the logical to virtual mapping table 304 that reference the entry in the virtual to physical mapping table 306 need not be updated after the copying operation.

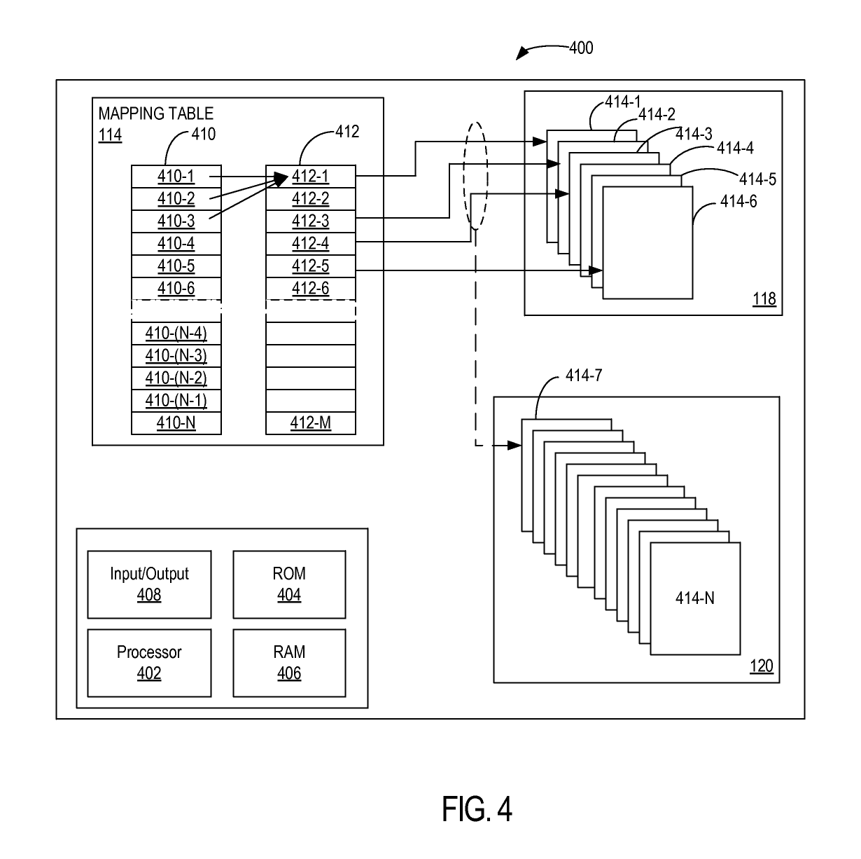

FIG. 4 is a block diagram of an example device 400 that may implement methods described herein to cause the storage, copying and reading of data and to perform the remapping described with reference to FIG. 3. Device 400 may correspond to storage device 102 of FIG. 1. Device 400 comprises a memory controller, 106 of FIG. 1 for example, mapping table 114 and memory 108. Memory controller 106 comprises processor 402, ROM 404, RAM 406, and input/output (I/O) interface 408. Mapping table 114 includes logical to virtual mapping table 410, and virtual to physical mapping table 412. Memory 108 comprises physical blocks 414-1 . . . 414-N, in an embodiment. The physical blocks may include a combination of intermediate memory 118 (SLC) physical blocks and main memory 120 (MLC) physical blocks. A physical block in intermediate memory 118, 414-1 for example, may have a size corresponding to 1 Megabytes (Mbytes). A physical block in main memory 120, 414-7 for example, may have a size corresponding to 3 Mbytes. Because the physical block 414-7 in main memory 120 is three times the size of a physical block, 414-1 for example, in intermediate memory 118, data stored in three physical blocks in intermediate memory 118 may be copied and stored in a single physical block in main memory 120.

In this embodiment, the processor 402 may copy software instructions from ROM 404 to RAM 406. The processor 402 may execute the software instructions to perform the steps of storing data received from the host via I/O interface 408 to one or more of the physical blocks 414-1 . . . 414-N, copying data from one or more physical blocks to another physical block and reading data from one or more physical blocks in response to receiving a request from the host. The I/O interface 408 may correspond to a serial interface such as the universal serial bus (USB) interface, a memory mapped interface or any other interface suitable for interfacing with the host.

Logical to virtual mapping table 410 may correspond to a series of entries 410-1 . . . 410-N, where N corresponds to the number of entries. Each entry may correspond to a register or a memory location. Similarly virtual to physical mapping table 412 may correspond to a series of entries 412-1 . . . 412-M, where M corresponds to the number of entries in the virtual to physical mapping table 412. Each entry in the virtual to physical mapping table 412 may correspond to a register or a memory location.

Each entry in the logical to virtual mapping table 410 corresponds to a logical block address. Thus, entry 410-1 may correspond to LBA 0; entry 410-2 may correspond to LBA 1 and so on. Each LBA corresponds to a cluster of non-volatile memory in a physical block in intermediate memory 118 or main memory 120. In one example, the size of a cluster may be 4096 bytes or 4 Kilobytes (Kbyte). In this example, each entry is associated with a 4 Kb cluster of non-volatile memory in a physical block.

In an exemplary embodiment, an entry in the virtual to physical mapping table 412 may include a reference to a physical block in intermediate memory 118 or main memory 120. For example, entry 412-1 may include a reference to physical block 414-1 in intermediate memory. In this embodiment, an entry in the logical to virtual mapping table 410 may include a reference to an entry in the virtual to physical mapping table 412 if data associated with the LBA corresponding to the entry in the in the logical to virtual mapping table 410 is stored in a storage block that is referenced by the entry in the virtual to physical mapping table 412. For example, if data associated with LBA 0 corresponding to entry 410-1 is stored in physical block 414-1 and if entry 412-1 includes a reference to physical block 414-1, the entry 410-1 may include a reference to entry 412-1.

The entry 410-1 may also include an offset into the physical block 414-1 where the 4 Kb cluster of data associated with LBA 0 is stored. If for example, the physical block 414-1 in intermediate memory is configured to store 1 Mb of data, 256 4-Kb clusters may be stored in one physical block (1 Mb/4 Kb=256). In this example, depending on where in the physical block 414-1 the 4 Kb cluster associated with the LBA 0 is stored, the offset included with entry 410-1 may have a value ranging from 0 to 255. For example, if the 4 Kb cluster is stored at the start of the physical block 414-1, the offset is 0. If the 4 Kb cluster is stored at the end of the physical block 414-1, the offset is 255.

In operation, in response to receiving a command from a host system to write data associated with a logical block address, memory controller 106 may locate an entry in the logical to virtual mapping table 410 based on the logical block address. In an embodiment, memory controller 106 may determine if the entry includes a reference to an entry in virtual to physical mapping table 412 and if the entry includes an offset into a physical block. If the entry includes a reference to an entry in virtual to physical mapping table 412, memory controller 106 may utilize the reference to retrieve the reference to the physical block that is stored in the entry in the virtual to physical mapping table 412. Based on the reference to the physical block and the offset into the physical block included in the located entry in the logical to virtual mapping table entry 410, memory controller 106 may store the data the physical block at the offset.

In another embodiment, in response to receiving the command from the host system to write data to a logical block address, memory controller 106 may identify a cluster in a physical block that is available to be written i.e. no data corresponding to another logical block address is stored at the offset corresponding to the cluster in the physical block. Memory controller 106 may write the received data to the cluster in the physical block. The physical block may be part of the intermediate memory 118 or main memory 120.

As previously mentioned, the logical block address received with the write command corresponds to an entry in the logical to virtual mapping table 410. After completion of the write, memory controller 106 may update the entry in the logical to virtual mapping table 410 with the offset of the cluster in the physical block to where the data was written. If an entry in the virtual to physical mapping table 412 already contains a reference to the identified physical block, the entry in the logical to virtual mapping table 410 may be updated with the reference to the entry in the virtual to physical mapping table 412. If none of the entries in the virtual to physical mapping table contain a reference to the identified physical block, an unused entry in the virtual to physical mapping table 412 may be updated with a reference to the identified physical block. The entry in the logical to virtual mapping table 410 may be updated with a reference to entry in the virtual to physical mapping table 412. In an embodiment, any cluster associated with the logical address block before the write command was received may be reclaimed and marked as unused by the memory controller 106. The order of the steps described above is not critical.

In the scenario where the logical block address has never been written to, the entry in the logical to virtual mapping table 410 corresponding to the logical block address may not include a reference to an entry in the virtual to physical mapping table 412. In this scenario, memory controller 106 may locate an offset in a physical block where a cluster is free and may store the data in the physical block at the located offset. Additionally, memory controller 106 may identify an entry in the virtual to physical mapping table 412 that includes a reference to the physical block. If an entry is located in the virtual to physical mapping table 412, memory controller 106 may store the reference in the entry in the logical to virtual mapping table 410 corresponding to the logical block address. The entry may also be updated with the offset in the physical block where the data was stored.

In the case where no entry is located in the virtual to physical mapping table 412 with a reference corresponding to physical block where the data was stored, the memory controller 106 may store the reference to the physical block in an unused entry in the virtual to physical mapping table 412. The memory controller 106 may then store a reference to this entry in the logical to virtual mapping table 410 corresponding to the logical block address along with an offset to the location in the physical block where the data was stored.

As was previously explained, a physical block in intermediate memory 118, 414-1 for example, may have a size corresponding to 1 Megabytes (Mbytes). A physical block in main memory 120 comprised of MLCs capable of storing 3 bits of information per MLC, 414-7 for example, may have a size corresponding to 3 Mbytes. Because the physical block 414-7 in main memory 120 is three times the size of a physical block, 414-1 for example, in intermediate memory 118, data stored in three physical blocks in intermediate memory 118 may be copied and stored in a single physical block in main memory 120.

In an exemplary embodiment, memory controller 106 may determine that all offsets in several physical blocks in intermediate memory 118 contain stored data. In this embodiment, memory controller 106 may copy the stored data from several physical blocks in intermediate memory to a single physical block in main memory 120. For example, in response to determining that all offsets in physical blocks 414-1, 414-2 and 414-3 contain stored data, memory controller 106 may copy data from physical blocks 414-1, 414-2 and 414-3 and store the data into physical block in 414-7. Data from physical block 414-1 may be copied to the lower third portion of block 417-1, data from physical block 414-2 may be copied to the middle third portion and data from physical block 414-3 may be copied to the top third portion of physical block 414-7.

In response to copying the data to physical block 414-7, memory controller 106 may update the entries 412-1, 412-3 and 412-4 with a reference to physical block 414-7. Separately, entry 412-1 may be updated with an index, 1 for example, to indicate that data from 414-1 was copied to the lower third portion of physical block 414-7, entry 412-3 may be updated with an index, 2 for example, to indicate that data from 414-2 was copied to the middle third portion of physical block 414-7 and entry 412-4 may be updated with an index, 3 for example, to indicate that data from physical block 414-3 was copied to the top third portion of physical block 414-7. This process of copying data from several storage blocks to a single storage block with a corresponding update to entries in the virtual to physical mapping table 412 may be referred to as remapping. The process of remapping does not include updating entries in the fine granularity (4 Kbyte) logical to virtual mapping table 410 and only includes updating the coarse granularity virtual to physical mapping table 412.

The host of FIG. 1 may command the memory controller 106 to read data for a logical block address. In response to receiving a request to read data, memory controller 106 may utilize the logical block address to retrieve an entry from the logical to virtual mapping table 410 corresponding to the logical block address. Memory controller 106 may retrieve an entry from the virtual to physical mapping table 412 corresponding to the reference stored in the entry retrieved from the logical to virtual mapping table 410. Based on the entry retrieved from the virtual to physical mapping table 412, the memory controller 106 may identify a physical block. As previously explained, the entry in the logical to virtual mapping table 410 includes an offset corresponding to where in the physical block, data associated with the logical block address was previously stored. Memory controller 106 may utilize this offset in conjunction with the identified physical block to read data associated with the logical block address. In scenarios where the data is stored in a physical block corresponding to main memory 120, 414-7 for example, memory controller 106 may use the identified physical block and the index described above to index into the appropriate portion of the physical block 414-7 and then use the offset in the entry retrieved from the logical to physical mapping table to read data associated with the logical block address from the appropriate portion.

In the above described scheme, the number of entries in the virtual to physical mapping table 412 is an order of magnitude less than the number of entries in the logical to virtual mapping table 410. For example, if the total size of all the physical blocks is 16 Mbytes, if each physical block has a size of 1 Mbytes and if a cluster of data associated with a logical block address is 4096 Kbytes, the logical to virtual mapping table 410 may be comprised of ((1048576*16)/4096) entries or 4096 entries. In contrast, the virtual to physical mapping table 412 may be comprised of only 16 entries or the number of physical blocks. Additionally, in this scheme when data is copied from several physical blocks having a lower density to another physical block with a higher density only one entry in the virtual to physical mapping table 412 needs to be updated.

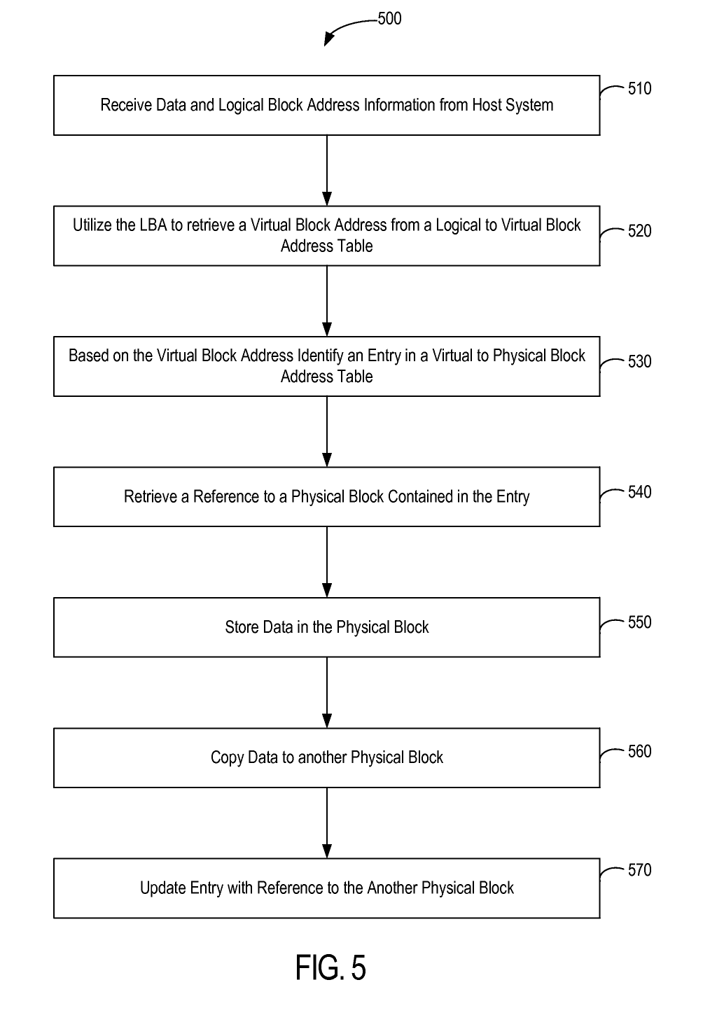

FIG. 5 is a flow diagram of an example method 500 that may be implemented in the memory controller of FIG. 4. In an embodiment, at block 510, information including data and a logical block address (LBA) may be received from the host system 102 (FIG. 1). Generally, the information may be a part of a command to write or store the data at a storage location corresponding to the LBA. The information may be received via the I/O interface 104. At block 520, the LBA may be utilized to retrieve a virtual block address from a logical to virtual mapping table 410 (FIG. 4), in an embodiment. The LBA may correspond to an index into the logical to virtual mapping table 410, in this embodiment. In this embodiment, the index may be utilized to retrieve information stored in the entry in the logical to virtual mapping table 410 corresponding to the index. The retrieved information may represent the virtual block address.

At block 530, the virtual block address retrieved from the logical to virtual mapping table 410 may be used to identify an entry in a virtual to physical mapping table 412. The virtual block address may represent a pointer to a memory location in the virtual to physical mapping table 412. Alternatively, the virtual block address may represent an index into the virtual to physical mapping table 412.

At block 540, a reference to a physical block stored in the entry identified from the virtual to physical mapping table 412 may be retrieved. At block 550, the data received at block 510 may be stored in the physical block corresponding to the reference stored in entry identified at block 540. In an embodiment, at block 550 after storing the data in the physical block, an indication may be communicated to the host system that the data has been stored.

At block 560, another physical block may be identified. For example, a physical block from main memory 120 may be selected. Selecting the physical block may include determining that the selected physical block is empty or not being used to store data associated with another LBA. Data may be copied to the identified physical block from the original physical block used at block 550.

At block 570, the entry in the virtual to physical table 412 identified at block 530 may be updated with a reference to the physical block selected at block 560. The physical block used to store data at block 550 may be tagged as being available for storing other data.

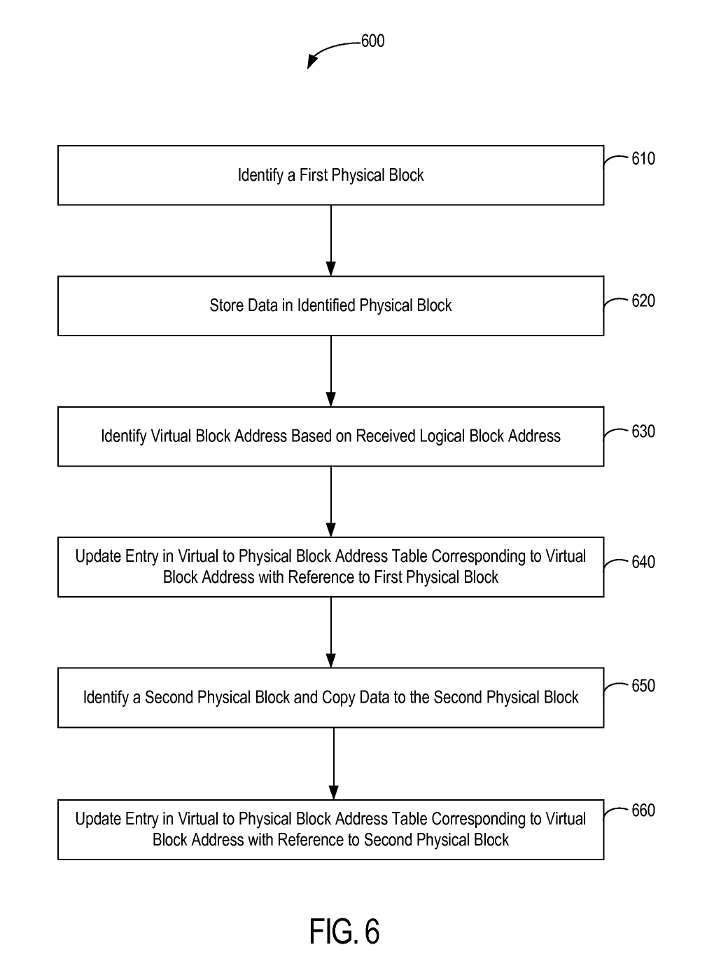

FIG. 6 is a flow diagram of another example method 600 that may be implemented to facilitate the copying of data from one physical block to another physical block and the remapping of the virtual block address without changing the logical block address associated with the data.

In an embodiment, at block 610, one or more physical block(s) may be identified. The physical block(s) may be identified in response to receiving a command to write data to a physical location. In an embodiment, the command to write data may also include the data and a logical block address (LBA). Identification of the physical block at block 610 may be based on the characteristics of the physical block. For example, in an embodiment a SLC type physical block may be identified from the intermediate memory 118 (FIG. 1). An SLC type physical block such as 414-1 (FIG. 4) may be selected because writing to an SLC type physical block takes lesser time than writing to an MLC type block 414-7 (FIG. 4). Additionally, in an embodiment, at block 610 only a physical block not being presently used for storage may be selected. In an embodiment, a table may be maintained that includes references to unused physical blocks. After identifying an unused SLC type storage block, the table may be adjusted to indicate that the identified block is being used.

At block 620, the data received at block 610 may be stored in the SLC type storage block(s) identified at block 610, in an embodiment. Referring to FIG. 4, at block 630, a virtual block address may be identified in the logical to virtual mapping table based on the logical block address (LBA) received at block 610. As previously explained the LBA may be utilized to index into the logical to virtual mapping table 410 and retrieve the virtual block address stored in an entry in the logical to virtual mapping table 410 corresponding to the LBA. For example if the LBA received is ‘5,’ the virtual block address stored at entry number 5 i.e. 410-5 in the logical to virtual mapping table 410 may be retrieved at block 630.

At block 630, the entry in the virtual to physical mapping table 412 corresponding to the virtual block address may be updated with a reference to the identified physical block(s). As previously explained, the virtual block address retrieved from the logical to physical mapping table may be used as an index into the virtual to physical mapping table 412 to retrieve the corresponding entry, 412-5 for example. In an embodiment, if the entry 412-5 contains a reference to another physical block, this physical block may be reclaimed and marked as being available.

At block 640, an unused MLC type physical block may be identified from the main memory 120, 414-7 for example, in an embodiment. The data stored in the SLC type physical block at block 620 may be copied to the MLC type physical block identified at block 640. At block 650, the reference to the SLC type physical block stored in the entry in the virtual to physical mapping table at block 630 may be updated with a reference to the MLC type physical block. The SLC type physical block may be reclaimed for future use.

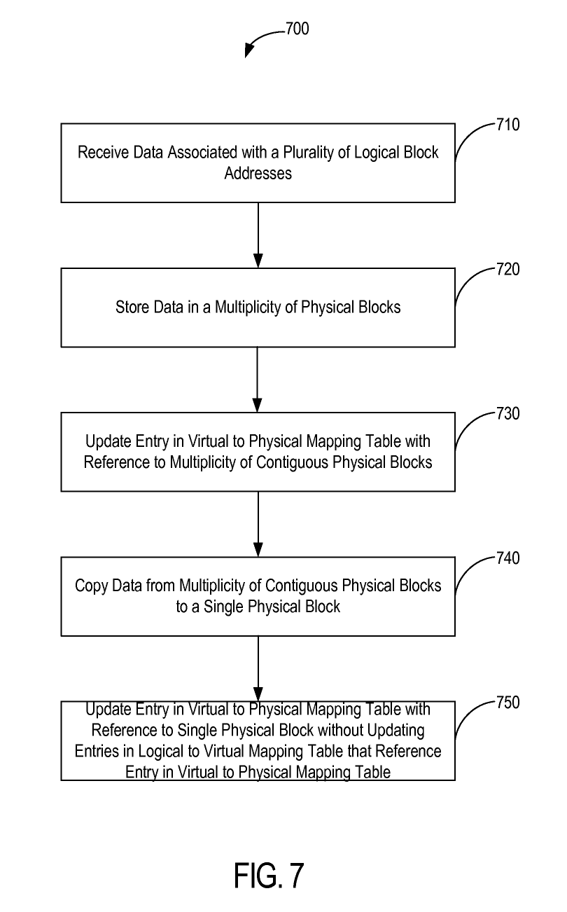

FIG. 7 is an example flow diagram of a method 700 for performing remapping of references to physical blocks after copying data for a first set of physical blocks to one or more second physical blocks. Method 700 may be implemented in the memory controller 106 of FIG. 1 and may utilize the logical to virtual mapping table and the virtual to physical mapping table discussed in the preceding paragraphs with reference to FIGS. 3 and 4.

At block 710, memory controller 106 may receive data to be stored. The received data may be associated with several logical block addresses. The data for all of the logical block addresses may be received at the same time, consecutively and in any order. With reference to FIG. 4, each logical block address may correspond to an entry in logical to physical mapping table 410, 410-1 for example.

At block 720, data associated with each of the logical block addresses may be stored in a plurality of contiguous physical blocks. For example, in response to receiving data to be stored in logical block addresses corresponding to entries 410-1, 410-2 and 410-3 of the logical to virtual mapping table 410, the data may be stored in physical blocks 414-1, 414-2 and 414-3. As was previously discussed with reference to FIG. 4 each of the entries 410-1, 410-2 and 410-3 may reference a single entry in the virtual to physical mapping table 412, entry 412-1 for example. The physical blocks may be contiguous in one embodiment. The physical blocks may each be comprised of SLCs.

At block 730, the entry in the virtual to physical mapping table 412, entry 412-1 for example, may be updated with one or more references to the physical blocks 414-1, 414-2 and 414-3 for example. In the embodiment where the physical blocks 414-1, 414-2 and 414-3 are contiguous, at block 730, entry 412-1 may be updated with a reference to first physical block, 414-1 for example.

Data from the physical blocks may be copied to a single physical block at block 740. In an embodiment, the single physical block may be comprised of MLCs. 414-7 for example. The single physical block may be capable of storing the data from multiple SLC type physical blocks. In another embodiment, the single physical block may be comprised of SLCs.

At block 750, the entry 412-1 in virtual to physical mapping table 412 is updated with a reference to the single physical block 414-7. However, the entries 410-1, 410-2 and 410-3 need not be updated and may continue to reference entry 412-1.

Although in foregoing discussion, the first physical block is described as comprising SLC type cells and the second physical block is described as comprising MLC type cells, in other embodiments, both the first and second physical blocks may correspond to physical blocks comprising either SLC type cells or MLC type cells.

A system and method that implements a block remapping layer in a mapping table of a memory system is provided. The block remapping layer is a virtual block to physical block remapping layer that may avoid the need to remap each cluster associated with a virtual block. The block remapping scheme discussed herein allows for the efficient copying of data stored in large physically contiguous storage blocks of data from one layer to another. In an exemplary embodiment, storage blocks in the two layers may be comprised of different type of flash memory cells (e.g., one layer might be SLC and one layer might be MLC).

As described in the foregoing logical block addresses are mapped via a fine granularity logical to virtual mapping table 410 to virtual physical blocks in the SLC layer. Virtual physical blocks are remapped to physical blocks in the MLC layer by the virtual to physical mapping table 412. Typically the virtual physical block size is a common multiple of the physical block sizes (of which several may exist if multiple layers of flash technology are used). When data is moved between physical blocks in large contiguous chunks of size a multiple of the virtual physical block size, rather than update multiple entries in the logical to physical fine granularity mapping table, a single (or few) entries in the block remap table may be adjusted to remap the virtual physical block to its new physical block location. This is typically the case when data is being moved between intermediate memory 118 in a storage device 108 to main memory 120 in the storage device 108.

Further embodiments can be envisioned by one of ordinary skill in the art after reading the foregoing. In other embodiments, combinations or sub-combinations of the above disclosed invention can be advantageously made. The block diagrams of the architecture and flow diagrams are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

We claim:

1. A method for managing data in a memory device, the memory device comprising a multiplicity of physical blocks in communication with a memory controller, wherein the method comprises the memory controller:
receiving information from a host, wherein the information comprises data and a logical block address associated with the data;
based on the logical block address, retrieving from a logical to virtual mapping table a virtual block address wherein the virtual block address corresponds to a one of a plurality of entries in a virtual to physical mapping table and wherein the one of the plurality of entries includes a reference to a one of a plurality of physical blocks;
storing the data in the plurality of physical blocks;
copying the stored data from the plurality of physical blocks to another physical block; and
replacing in the one of the plurality of entries in the virtual to physical mapping table the reference to the first physical block with a reference to the second physical block without changing the virtual block address associated with the logical block address in the logical to virtual mapping table.

2. The method of claim 1, further comprises transmitting an indication to the host after storing the data in the first physical block.

3. The method of claim 1, further comprises in response to receiving a request to read the data corresponding to the logical block address, reading the data stored in the second physical block.

4. The method of claim 1, wherein storing the data in the plurality of physical blocks is based on the reference to the one of the plurality of physical blocks.

5. The method of claim 1, wherein copying the stored data is in response to identifying the another physical block, wherein identifying the another physical block is based on a characteristic of the another physical block.

6. The method of claim 5, wherein identifying the another block is based on determining the another physical has a size equal to greater that a sum of the sizes of the plurality of physical blocks.

7. A method implemented in a memory controller, the method comprising:
copying data stored in a first physical block of a flash device to a second physical block of the first flash device wherein the first physical block has a first cell density different from a second cell density of the second physical block; and
replacing in a one of a plurality of entries in a virtual to physical mapping table, a reference to the first physical block with a reference to the second physical block, wherein the one of the plurality of entries corresponds to a respective logical block address stored in a logical to virtual mapping table.

8. The method of claim 7, wherein copying the data is in response to receiving a command from a host system to store data at the respective logical block address.

9. The method of claim 8, further comprising the memory controller in response to receiving the command identifying the first physical block based on the first cell density and storing the data in the first physical block.

10. The method of claim 9, further comprising the memory controller in response to identifying the first physical block storing the data in the first physical block.

11. The method of claim 10, further comprising the memory controller storing in the one of the plurality of entries the reference to the first physical block.

12. The method of claim 11, further comprising the memory controller in response to storing in the one of the plurality of entries the reference to the first physical block, transmitting to the host system an indication of completion of the command.

13. The method of claim 12, further comprising the memory controller in response to storing in the one of the plurality of entries the reference to the first physical block identifying the second physical block based on the second cell density of the second physical block.

14. The method of claim 13 wherein identifying the second physical block based on the second cell density of the second physical block is based on determining that a size of the second physical block is greater than a size of the first physical block.

15. An memory device comprising:
a flash memory comprising a plurality of physical blocks;
a logical to virtual mapping table;
a virtual to physical mapping table; and,
a memory controller configured to retrieve from the logical to virtual mapping table a virtual block address wherein the virtual block address corresponds to a one of a plurality of entries in the virtual to physical mapping table and wherein the one of the plurality of entries includes a reference to a one of the plurality of physical blocks;
store the data in the one of the plurality of physical blocks based on the reference;
copy the stored data from the one of the plurality of physical blocks to another one of the plurality of physical blocks; and
replace in the one of the plurality of entries the reference to the one of the plurality of physical blocks with a reference to the another one of the plurality of physical blocks.

16. The apparatus of claim 15, wherein the plurality of physical blocks comprises a first set of physical blocks and a second set of physical blocks wherein each of the first set of physical blocks has a first cell density and each of second set of physical blocks has a second cell density.

17. The apparatus of claim 16 wherein the memory controller is configured to select the one of the plurality of physical blocks from the first set of physical blocks.

18. The apparatus of claim 16 wherein the memory controller is configured to select the another one of the plurality of physical blocks from the second set of physical blocks.

19. The apparatus of claim 16 wherein each of the first set of physical blocks is comprised of single level cells and wherein each of the second set of physical blocks is comprised of multi-level cells.
